(19) United States
(12) Patent Application Publication
(10) Pub. No.: US 2024/0118378 A1
(43) Pub. Date: Apr. 11, 2024

(54) Delay compensation for a geolocation measurement with downlink reference signals

(71) Applicant: ORANGE, Issy-les-Moulineaux (FR)

(72) Inventor: Philippe Chanclou, CHATILLON CEDEX (FR)

(21) Appl. No.: 18/262,293

(22) PCT Filed: Jan. 21, 2022
(86) PCT No.: PCT/FR2022/050117

§ 371 Date: Jul. 20, 2023

(30) Foreign Application Priority Data
Jan. 22, 2021 (FR) 2100628

(51) Int. Cl. G01S 5/10; H04L 5/00

(52) U.S. Cl. CPC G01S 5/10; H04L 5/0048

(57) ABSTRACT

A method for transmitting a downlink reference signal from a network entity to a mobile terminal via a radio unit connected to an antenna, used to geolocate the mobile terminal. The method is implemented by the radio unit and includes: receiving the reference signal from the network entity and destined for the mobile terminal; and transmitting the reference signal to the mobile terminal upon expiry of a delay period with respect to the transmission time of the reference signal by the network entity. The delay period has a value greater than a transmission travel time of a comparison signal between the network entity and the radio unit.

### 1. CROSS REFERENCE TO RELATED APPLICATIONS

This application is a Section 371 National Stage Application of International Application No. PCT/FR2022/050117, filed Jan. 21, 2022, the content of which is incorporated herein by reference in its entirety, and published as WO 2022157462 on Jul. 28, 2022, not in English.

### 2. FIELD OF THE INVENTION

The present invention relates to the field of geolocation of mobile terminals, for example geolocation by means of a triangulation technique using the antennas near to a mobile terminal.

### 3. PRIOR ART

It has applications, notably, in the calculation of the distance between a transmitter and a mobile terminal by estimating the times of arrival or the time differences of arrival.

For example, these estimates may be provided by measurements of reference signal time differences (RSTD) by the mobile terminal whose geolocation is to be determined. For the purpose of measuring the RSTD, reference signals, such as positioning reference signals (PRS) may be sent by the distributed unit, or “digital unit” (DU) of the radio access network (RAN) to the mobile terminal. Thus the reference signal sent by the DU is transmitted to a radio unit (RU) of an antenna, and then to the mobile terminal that is to be geolocated. Regardless of whether the measurement is made by sending reference signals from the DUs to the mobile terminal, as described above, that is to say via a downlink channel, or whether the measurement is made by sending reference signals from the mobile terminal to the DUs, that is to say via an uplink channel, the transit times of the reference signals between the antenna(s) and the mobile terminal must be known in order to obtain a precise estimate of the geolocation by using the times of arrival or the time differences of arrival. These transit times for the transmission of the reference signals between the antennas (or RUs located near the antennas, which is not necessarily the case with the DUs) and the mobile terminal can be deduced from the transit time between the DU and the mobile terminal, that is to say the time taken by the reference signals to travel between the DUs and the mobile terminal, because the time taken by the reference signals to travel between DUs and RUs is considered to be negligible. In fact, the geolocation techniques used at present were designed at a time when the functions performed by DU and RU equipments were combined in a single equipment, or at least co-located near the antenna. However, it is becoming increasingly common for DU and RU equipments to be remote from one another, at distances varying from a few meters to several tens of kilometers. The transit time between these equipments is no longer negligible, and this invalidates the geolocation measurements.

One of the objects of the invention is to overcome these drawbacks of the prior art.

### 4. DISCLOSURE OF THE INVENTION

The invention is intended to improve the situation by using a method of transmitting a reference downlink signal from a network entity to a mobile terminal via a radio unit connected to an antenna, used for geolocation of the mobile terminal, the method being implemented by the radio unit and comprising:
receiving the reference signal sent from the network entity and intended for the mobile terminal, and
sending the reference signal to the mobile terminal, on the expiry of what is called a delay period relative to the instant of transmission of the reference signal by the network entity, the value of the delay period being greater than a transmission transit time of a signal, called a comparison signal, between the network entity and the radio unit.

Thus, regardless of the transit time of a signal between the network entity and the radio unit, the duration of which depends on the distance traveled and on transmission conditions that vary with time, it is possible to deduce the transit time of this signal between the antenna of the radio unit and the mobile terminal, that is to say the transit time through the air (also called the time of flight), simply by knowing the value of the delay and the total transit time between the network entity and the mobile terminal. This is because the transit times through the air of the reference signals, also called the times of flight, between a plurality of antennas and a mobile terminal can be used for the precise calculation of the position of the terminal relative to these antennas. Advantageously, as a result of the proposed method, the portion of the transit time upstream of an antenna, which is equal to the delay, is constant regardless of the distance traveled and the transmission conditions, and can therefore be subtracted from the total transit time between the network and the terminal, to find the time of flight. Thus the proposed method compensates for the transmission delays due to the non-air part of the paths of the reference signals used to determine the geolocation of a terminal.

The comparison signal may be any signal between the network entity and the radio unit, including the reference signal itself.

According to an aspect of the proposed method, the method comprises the measurement of a value of the transmission transit time of the comparison signal.

Because of this aspect, the radio unit can check that the delay actually exceeds the transit time of a comparison signal, and can initiate a procedure for updating the value of the delay if this is not the case.

According to an aspect of the proposed method, the comparison signal is the reference signal.

Because of this aspect, no special signal other than the reference signal itself is required for the proposed method.

According to an aspect of the proposed method, the comparison signal is a separate signal from the reference signal.

Because of this aspect, the measurement of the transit time of a comparison signal can be carried out by the radio unit before the processing of the reference signal, and independently of the latter.

According to an aspect of the proposed method, it comprises sending to the network entity the measured value of the transmission transit time of the comparison signal.

Because of this aspect, the network entity, or another entity located farther upstream, may determine a value of the delay which exceeds the transit time of a comparison signal.

According to an aspect of the proposed method, it comprises receiving a message comprising the value of the delay period.

In this mode, the radio unit applies to the reference signal a delay that is specified to it, and does not need to determine it itself. In this mode, it is the network entity that supplies the delay to be applied to the radio unit, possibly but not necessarily on the basis of a measurement of the transmission transit time of a comparison signal that is sent to it by the radio unit.

According to an aspect of the proposed method, it comprises:
determining the value of the delay period on the basis of the measured value of the transit time of the comparison signal, and
transmitting a message comprising the determined value of the delay period to the network entity.

In this mode, the radio unit itself determines the delay that it applies to the reference signal. The radio unit must then communicate the value of this delay, so that the entity responsible for geolocation can correct the information sent to it concerning the transit times of the reference signals.

The radio unit can easily send the message comprising the value of the delay to the network entity that sends the reference signal. The network entity, in turn, can then transmit the value of the delay to the entity responsible for geolocation.

According to an aspect of the proposed method, it comprises:
determining the value of the delay period on the basis of the measured value of the transit time of the comparison signal, and
transmitting a message comprising the determined value of the delay period to the mobile terminal.

Alternatively, the radio unit can also easily send the message comprising the value of the delay to the mobile terminal. In this case, the mobile terminal can itself calculate the time of flight of each of the reference signals between the network entity and itself. Instead of sending RSTD to the network entity, the terminal sends the calculated times of flight.

This means that the entity responsible for estimating geolocation does not have to retrieve the delay value, because the times of flight have already been calculated.

The various aspects of the method for transmitting a reference downlink signal described above may be implemented independently of each other or in combination with each other.

The invention also relates to a device for transmitting a reference downlink signal from a network entity to a mobile terminal via a radio unit connected to an antenna and used for geolocation of the mobile terminal, the device being included in the radio unit and comprising a receiver, a transmitter, a processor and a memory coupled to the processor with instructions to be executed by the processor for:
receiving the reference signal sent from a network entity and intended for the mobile terminal, and
transmitting the reference signal to the mobile terminal on the expiry of a delay period relative to the instant of transmission of the reference signal by the network entity, the value of the delay period being greater than a transmission transit time of a signal, called the comparison signal, between the network entity and the radio unit.

This device, which in all of its embodiments is capable of implementing the method for transmitting a reference downlink signal as described above, is intended to be implemented in a radio unit.

The invention also relates to a computer program comprising instructions which, when these instructions are executed by a processor, cause the processor to implement the steps of the method for transmitting a reference downlink signal as described above.

The invention also relates to a data medium which is readable by the device for transmitting a reference downlink signal as described above, and which includes instructions of a computer program as mentioned above.

The program mentioned above may use any programming language, and may be in the form of source code, object code, or a code intermediate between source code and object code, such as a code in partially compiled form, or any other desirable form.

The data medium mentioned above may be any entity or device capable of storing the program. For example, a medium may comprise a storage means such as a ROM, for example a CD-ROM or a microelectronic circuit ROM, or a magnetic recording means.

Such a storage means may be, for example, a hard disk, a flash memory, or the like. On the other hand, a data medium may be a transmissible medium such as an electrical or optical signal, which may be routed via an electrical or optical cable, by radio or by other means. A program according to the invention may, in particular, be downloaded from a network such as the internet.

Alternatively, a data medium may be an integrated circuit in which a program is incorporated, the circuit being adapted to execute the method in question or to be used in its execution.

### 5. DESCRIPTION OF THE FIGURES

Other advantages and characteristics of the invention will be more fully evident from the following description of a particular embodiment of the invention, provided as a simple illustrative and non-limiting example, and from the appended drawings, of which:

FIG. 1 shows schematically a network entity, a radio unit and a mobile terminal according to an embodiment of the invention,

FIG. 2 shows an example of implementation of the method for transmitting a reference downlink signal according to one embodiment of the invention,

FIG. 3 shows an example of a structure of a device for transmitting a reference downlink signal according to an aspect of the invention.

### 6. DETAILED DESCRIPTION OF AT LEAST ONE EMBODIMENT OF THE INVENTION

The expression “transmission conditions” is to be understood as meaning both the conditions within the network (prioritization, resource allocation, routing path, buffer memory storage, channel coding, etc.) and the conditions external to the network (timetable, temperature variation, major traffic fluctuation, electromagnetic parasites, etc.). These transmission conditions have a more or less significant effect on the signal transmission time. The expression “signals used for estimating the position of a terminal” is to be understood as meaning the signals used for determining transit times between two points in the network, for example between a mobile terminal whose position is to be determined and a network entity, via a radio antenna or a radio unit whose position is known (for example, a signal to enable a transmission transit time to be measured between the network entity and the mobile terminal via the radio unit), or between the network entity and the radio unit (for example, a signal to enable a transmission transit time to be measured over part of a communication network between the network entity and the radio unit). These signals may be reference signals. Thus, if the network entity is the one that transmits the signals and the mobile terminal is the one that receives them, that is to say if the downlink is used, then the signals used may be positioning reference signals (PRS). These PRS sequences are particularly advantageous in that they have good autocorrelation properties and low cross-correlation properties, thus enabling the PRS to be extracted precisely in order to measure their arrival times.

The expression “radio unit” is to be understood as meaning the radio transceiver that processes or produces the electrical signal transmitted to the antenna or received from the antenna, and which corresponds to the radio signal transmitted or received by the antenna. “Radio unit” is the term used in the 5G standard, but this unit may also be called a “remote radio head” (RRH) or “radio remote unit” (RRU). This radio unit is separate from the network entity.

The expression “mobile terminal receiving radio signals” is to be understood as meaning that the terminal can decode, at least partially, the signals that it receives from the radio unit. The mobile terminal may be connected to the base station corresponding to the radio unit. The network entity may be a distributed unit (this is the term used in the 5G standard), also called a “digital unit” or “base band unit” (BBU). This may be included in a base station or possibly co-located with a centralized unit (CU). The network entity is connected to the radio unit by optical and/or microwave links, over distances ranging from several meters to several tens of kilometers. The network entity may be used for processing the digital data sent to and from the radio unit, which receives and transmits these data in the form of radio waves. The transmission transit time of a signal between the network entity and the radio unit may be measured by any known technique, in either direction. When the network entity and the radio unit are synchronized, as is the case in the 5G standard, one measurement of the transmission transit time may be made by sending a signal comprising information relating to the moment of its transmission, and the receiver may then compare the moment of arrival with the moment of transmission of the signal. In the last-mentioned case, the transmission transit time between the network entity and the radio unit may then be measured by the network entity when the radio unit sends the second signal, or by the radio unit when the network entity sends the second signal. In the last-mentioned case, the radio unit may transmit this measurement to the network entity if necessary (whenever the network entity uses this measurement and has not calculated it itself, it obtains it via the radio unit).

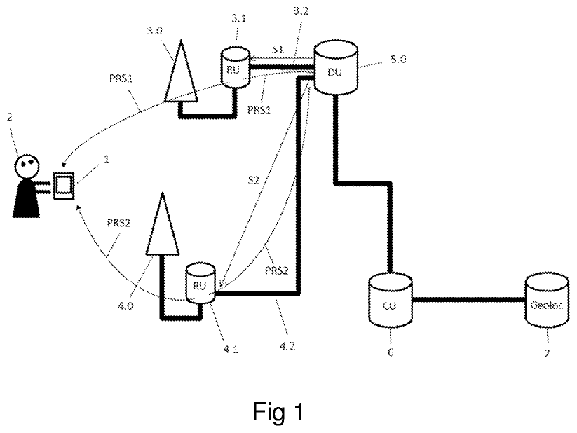

FIG. 1 shows schematically a network entity, a radio unit and a mobile terminal according to an embodiment of the invention.

In the example of FIG. 1, the mobile terminal 1 of a user 2 is in the radio coverage of two radio antennas 3.0 and 4.0.

The mobile terminal 1 receives the signals produced by the radio units (RU) 3.1 and 4.1 and transmitted by the antennas 3.0 and 4.0 respectively. Each of the radio units 3.1 and 4.1 is connected to a network entity 5.0. The links 3.2 and 4.2 between the network entity and the radio units 3.1 and 4.1 may be optical or electrical links. The network entity 5.0 in the 5G standard is a distributed unit (DU). This network entity 5.0 sends the radio units 3.1 and 4.1 signals which the radio units 3.1 and 4.1 convert into electrical signals, inducing radio signals via the antennas 3.0 and 4.0, and vice versa. The radio unit 3.1 and the network entity 5.0 may be co-located, in which case the link between the radio unit and the network entity 5.0 is short, being a few meters long for example. The network entity 5.0 may also be located at a distance from the radio unit 4.1, at a distance of several kilometers or tens of kilometers for example.

In the example of FIG. 1, a single network entity 5.0 is shown for the two radio units 3.1 and 4.1. However, each radio unit 3.1 and 4.1 may be served by a separate network entity, although this is not shown in the figure, but in this case the implementation of the invention does not require any particular modification of the implementation described in FIG. 1.

In the example of FIG. 1, a centralized unit (CU) 6 is also connected to the network entity 5.0. In the 5G standard, the separation of functions of a base station means that it may consist of a centralized unit CU connected to one or more network entities DU, each DU being connected to one or more radio units RU.

The geolocation of the mobile terminal 1 is carried out by means including the use of a measurement relating to the transmission transit time of signals, for example reference signals such as PRSs, between the network entity 5.0 and the mobile terminal 1.

The network entity 5.0 sends a PRS, denoted PRS1, to the mobile terminal 1 via the radio unit 3.1, and another PRS, denoted PRS2, to the mobile terminal 1 via the radio unit 4.1. The mobile terminal 1 then measures the time difference RSTD between the moments of reception of these two PRS signals. However, the resulting RSTD (Reference Signal Time Difference) does not allow for the transmission transit time of the signals PRS1 and PRS2 over the links 3.2 and 4.2, which do not have the same transmission characteristics. The transmission transit times of the signals PRS1 and PRS2 over the links 3.2 and 4.2, that is to say between the network entity 5.0 and the radio units 3.1 and 4.1 respectively, are denoted t1 and t2 respectively. The times t1 and t2 may be measured using dedicated signals S1 and S2, called comparison signals, in the control plane. Alternatively, this measurement may likewise be made directly on the signals PRS1 and PRS2 by the radio units 3.1 and 4.1. In this case, the reference signals PRS1 and PRS2 also act as comparison signals.

According to the prior art, the geolocation of the mobile terminal 1 is estimated on the basis of a direct measurement of the difference in transmission transit times of PRS1 and PRS2, that is to say the RSTD. However, this method of geolocation is imprecise, because it does not allow for the difference between the times t1 and t2 in the calculation of the RSTD.

The transmissions of PRS1 and PRS2 for determining the RSTD are initiated by sending a request to the geolocation server 7 (Geoloc) for the positioning of the mobile terminal 1. This may be requested by an application from the mobile terminal 1, or by a request external to the terminal, issued by an authority separate from the operator for example, for the geolocation of a person, that is to say the user 2 of the mobile terminal 1.

The server 7 sends a request to the centralized unit 6 which controls the network entity 5.0 so as to obtain the data required for the geolocation of the mobile terminal 1. The centralized unit 6 then sends a control message to the network entity 5.0 to initiate the transmission of the PRS1 and PRS2.

According to an aspect of the invention, the radio units 3.1 and 4.1 delay the PRS1 and PRS2 when they receive them, before sending them to the mobile terminal 1. The delay t12* applied is the same for all the radio units, and is calculated, relative to the instant of transmission of the reference signals PRS1 and PRS2, by the network entity. Thus, the times t1 and t2, being constant and all having a value which is that of the delay t12*, no longer need to be measured. However, it may be necessary to check occasionally that the value of the delay t12* is still well above those of the times t1 and t2, using one-off measurements that the radio units can make. Conversely, the geolocation server 7 can perform a precise geolocation without knowing the times t1 and t2 or their difference.

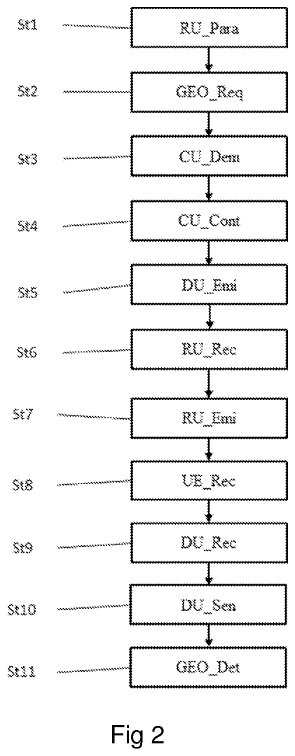

FIG. 2 shows an exemplary implementation of the method for transmitting a reference downlink signal, according to one embodiment of the invention.

In a step St1, the radio units are parameterized: that is to say, a value of the delay t12* is recorded in the memory for each of the radio units 3.1 and 4.1. These values are communicated to the radio units 3.1 and 4.1, by the network entity 5.0 for example, and may be identical or specific to the radio unit.

In a step St2, the server 7 receives a request for geolocation of the mobile terminal 1, for example a request sent by a monitoring entity farther upstream in the network, or by an application in the mobile terminal 1.

In a step St3, the server 7 sends a request to measure the RSTD to the centralized unit 6.

In a step St4, the centralized unit 6 sends a message via a control channel to the network entity 5.0 to initiate the protocol for measuring the transit times of the PRSs. The central unit may also send this message to other network entities to which other radio units, not shown, are connected.

In a step St5, the network entity 5.0 that has received the message sends the reference signals PRS1 and PRS2, PRS1 being sent to the mobile terminal 1 via the radio unit 3.1 and PRS2 being sent to the mobile terminal 1 via the radio unit 4.1. The reference signals are time-stamped at the instant of their transmission by the network entity 5.0.

The network entity 5.0 also sends the comparison signals S1 and S2, in the control plane, to the radio units 3.1 and 4.1 respectively. The comparison signals are time-stamped at the instant of their transmission by the network entity 5.0. In a variant, the reference signals act as comparison signals, and the signals S1 and S2 do not have to be sent. In the following text, for the sake of simplicity, a mention of these comparison signals may signify both signals that are either distinct from or identical to the reference signals.

The reference signals PRS1, PRS2 and the comparison signals S1 and S2 may be sent periodically.

If one of the radio units 3.1 and 4.1 detects that the transit time of a comparison signal is greater than its delay period t12* stored in step St1, then, in a step St5* that is not shown in FIG. 2, this radio unit sends a warning message, to the network entity 5.0 for example, so that the value of the delay period is revised upwards. The warning message may possibly comprise the measured value of the transit time of the comparison signal. If it is the radio unit that determines the new value of its delay period, then this new value may be included in the warning message to the network entity.

The method then stops or returns to step St1.

In a step St6, the radio units 3.1 and 4.1 receive the signals PRS1 and PRS2 sent by the network entity 5.0. The transit times between the network entity 5.0 and the radio unit 3.1 and the radio unit 4.1, respectively, are denoted t1 and t2 respectively. Instead of immediately sending the received reference signal (PRS1 or PRS2) to the mobile terminal 1, the radio unit 3.1 (or the radio unit 4.1 respectively) waits, before sending the signal, for the expiry of its delay period t12*, which has been stored in step St1, and is greater than t1 (or t2, respectively).

In a step St7, on the expiry of its delay period t12*, the radio unit 3.1 (or 4.1 respectively) sends the signal PRS1 (or PRS2 respectively) to the mobile terminal 1.

In a step St8, the mobile terminal 1 receives, at instants that are a priori different, the signals PRS1 and PRS2 sent by the network entity 5.0 via the radio units 3.1 and 4.1 respectively, after times of flight that are a priori different. The mobile terminal 1 calculates the RSTD on the basis of PRS1 and PRS2, that is to say the difference between the times of flight of the reference signals PRS1 and PRS2, and sends the result RSTD to the network entity 5.0.

In a step St9, the network entity 5.0 receives the measurement RSTD of the time difference between the moments when PRS1 and PRS2 were received by the mobile terminal 1.

In a step St10, the network entity 5.0 sends the RSTD to the server 7.

In a step St11, the network entity 5.0 sends the delay period(s) corresponding to the RSTD to the server 7, possibly at the request of the server 7. Thus the server 7 can determine the times of flight of the reference signals PRS1 and PRS2 on the basis of RSTD and t12*. The server 7 can then determine a position of the mobile terminal 1 on the basis of the times of flight of the signals PRS1 and PRS2, and possibly on the basis of other measurements of times of flight made separately in another network entity or entities and other radio units connected to other antennas.

There is a maximum time limit between a network entity and a radio unit. This is because the network entity constantly calculates a parameter called the “timing advance” with each of the radio units in order to synchronize the information sent and received. This time calculation must remain below a limit in order to maintain effective communication (typically <1 ms). The delay period t12* must therefore be set so as to preserve a margin of time on the total propagation time between the network entity and the mobile terminal. However, it is not advisable to set t12* arbitrarily at 500 μs to cover all cases. For example, the delay period t12* between the network entity 5.0 and the radio unit 3.1 may be set at a value 10% greater than the time t1.

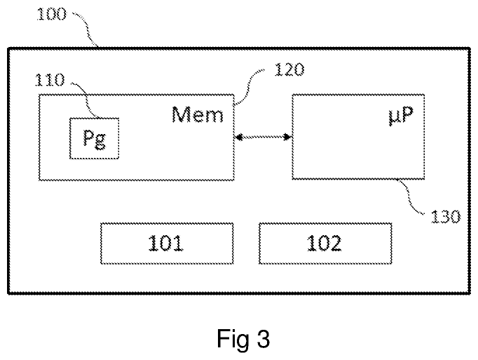

FIG. 3 shows an example of a structure of a device for transmitting a reference downlink signal according to an aspect of the invention.

The transmission device 100 implements the method for transmitting a reference downlink signal, different embodiments of which have been described above.

Such a device 100 may be implemented in a radio unit RU.

For example, the device 100 comprises a receiver 101, a transmitter 102, and a processing unit 130 equipped, for example, with a microprocessor μP, and controlled by a computer program 110 stored in a memory 120 and implementing the method for transmitting a reference downlink signal according to the invention. On initialization, the code instructions of the computer program 110 are, for example, loaded into a RAM memory, before being executed by the processor of the processing unit 130.

Such a memory 120, such a processor of the processing unit 130, such a receiver 101 and such a transmitter 102 are capable of, and configured for:
receiving a reference signal sent from a network entity DU and intended for a mobile terminal 1, and
transmitting a reference signal to a mobile terminal 1, on expiry of a delay period reckoned from the instant of transmission of the reference signal by a network entity DU, the value of the delay period being greater than a transmission transit time of a signal called a comparison signal, between the network entity DU and the radio unit comprising the device 100.

Advantageously, they are also capable of, and configured for:
measuring a value of the transmission transit time of the comparison signal,
transmitting to a network entity DU the measured value of the transmission transit time of the comparison signal,
receiving a message comprising the value of the delay period,
determining the value of the delay period on the basis of the measured value of the transit time of the comparison signal,
transmitting a message comprising the determined value of the delay period to the network entity DU, and
transmitting a message comprising the determined value of the delay period to the mobile terminal 1.

The entities described and included in the device described in relation to FIG. 3 may be hardware or software. FIG. 3 shows only one particular way, out of several possible ways, of implementing the algorithm detailed above with reference to FIGS. 1 and 2. In fact, the technique according to the invention can be implemented equally well on a reprogrammable computing machine (a PC, a DSP processor, or a microcontroller) executing a program comprising a sequence of instructions or on a dedicated computing machine (for example, a set of logic gates such an FPGA or an ASIC, or any other hardware module).

If the invention is embedded in a reprogrammable computing machine, the corresponding program (that is to say, the sequence of instructions) may or may not be stored in a removable storage medium (such as a USB drive, a diskette, a CD-ROM or a DVD-ROM), this storage medium being partially or entirely readable by a computer or a processor.

Although the present disclosure has been described with reference to one or more examples, workers skilled in the art will recognize that changes may be made in form and detail without departing from the scope of the disclosure and/or the appended claims.

1. A method for transmitting a reference downlink signal from a network entity to a mobile terminal via a radio unit connected to an antenna, used for geolocation of the mobile terminal, the method being implemented by the radio unit and comprising:
receiving the reference downlink signal sent from the network entity and intended for the mobile terminal; and
transmitting the reference downlink signal to the mobile terminal on expiry of a delay period relative to an instant of transmission of the reference downlink signal by the network entity, a value of the delay period being greater than a transmission transit time of a comparison signal, between the network entity and the radio unites.

2. The method as claimed in claim 1, comprising measuring a value of the transmission transit time of the comparison signal.

3. The method as claimed in claim 1, wherein the comparison signal is the reference downlink signal.

4. The method as claimed in claim 1, wherein the comparison signal is a signal distinct from the reference downlink signal.

5. The method as claimed in claim 2, comprising transmitting, to the network entity, the measured value of the transmission transit time of the comparison signal.

6. The method as claimed in claim 1,
comprising receiving a message comprising the value of the delay period.

7. The method as claimed in claim 2, comprising:
determining the value of the delay period on the basis of the measured value of the transit time of the comparison signal, and
transmitting a message comprising the determined value of the delay period to the network entity.

8. The method as claimed in claim 2, comprising:
determining the value of the delay period on the basis of the measured value of the transit time of the comparison signal, and
transmitting a message comprising the determined value of the delay period to the mobile terminal.

9. A device for transmitting a reference downlink signal from a network entity to a mobile terminal via a radio unit connected to an antenna, used for geolocation of the mobile terminal, the device being included in the radio unit and comprising:
a receiver, a transmitter, a processor and a memory coupled to the processor with instructions stored thereon to be executed by the processor to:
receive the reference downlink signal sent from a network entity and intended for the mobile terminal; and
transmit the reference downlink signal to the mobile terminal on the expiry of a delay period relative to an instant of transmission of the reference downlink signal by the network entity, a value of the delay period being greater than a transmission transit time of a comparison signal, between the network entity and the radio unit.

10. (canceled)

11. A non-transitory computer readable data medium comprising instructions of a computer program stored thereon which when executed by a radio unit of a cellular network configure the radio unit to implement a method of transmitting a reference downlink signal from a network entity to a mobile terminal via the radio unit, which is connected to an antenna, the reference downlink signal being used for geolocation of the mobile terminal, the method comprising:
receiving the reference downlink signal sent from a network entity and intended for the mobile terminal; and
transmitting the reference downlink signal to the mobile terminal on expiry of a delay period relative to an instant of transmission of the reference downlink signal by the network entity, a value of the delay period being greater than a transmission transit time of a comparison signal, between the network entity and the radio unit.
